(19) United States
(12) Patent Application Publication
(10) Pub. No.: US 2021/0090260 A1
(43) Pub. Date: Mar. 25, 2021

(54) DEPOSIT DETECTION DEVICE AND DEPOSIT DETECTION METHOD

(71) Applicant: DENSO TEN Limited, Kobe-shi (JP)

(72) Inventors: Nobuhisa IKEDA, Kobe-shi (JP); Nobunori ASAYAMA, Kobe-shi (JP); Takashi KONO, Kobe-shi (JP); Yasushi TANI, Kobe-shi (JP); Daisuke YAMAMOTO, Kobe-shi (JP); Daisuke SHIOTA, Kobe-shi (JP); Teruhiko KAMIBAYASHI, Kobe-shi (JP)

(73) Assignee: DENSO TEN Limited, Kobe-shi (JP)

(21) Appl. No.: 17/017,533

(22) Filed: Sep. 10, 2020

(30) Foreign Application Priority Data
Sep. 20, 2019 (JP) 2019-172204

(51) Int. Cl. G06T 7/11; G06T 7/13; G06T 7/00; G06T 7/60; G06T 7/136; G06T 7/162

(52) U.S. Cl. CPC G06T 7/11; G06T 7/13; G06T 7/162; G06T 7/60; G06T 7/136; G06T 7/0002

(57) ABSTRACT

A deposit detection device according to an embodiment includes an extraction module and a detection module. The extraction module extracts a candidate region for a deposit from a captured image captured by an imaging device. The detection module detects, as a deposit region, a region in which the area of the candidate region is equal to or larger than a predetermined area and the amount of brightness change between pixels in the candidate region is equal to or smaller than a predetermined amount of change.

### CROSS-REFERENCE TO RELATED APPLICATION

This application is based upon and claims the benefit of priority of the prior Japanese Patent Application No. 2019-172204, filed on Sep. 20, 2019, the entire contents of which are incorporated herein by reference.

### FIELD

The embodiments discussed herein are directed to a deposit detection device and a deposit detection method.

### BACKGROUND

Conventionally, a deposit detection device is known which detects a deposit adhering to a lens based on a brightness distribution of pixels in a captured image (for example, refer to Japanese Laid-open Patent Publication No. 2019-128798).

Unfortunately, with the conventional technique, when a deposit adhering to the lens is large, the accuracy in deposit detection may be reduced.

### SUMMARY

A deposit detection device according to an embodiment includes an extraction module and a detection module. The extraction module extracts a candidate region for a deposit from a captured image captured by an imaging device. The detection module detects, as a deposit region, a region in which the area of the candidate region is equal to or larger than a predetermined area and the amount of brightness change between pixels in the candidate region is equal to or smaller than a predetermined amount of change.

### BRIEF DESCRIPTION OF DRAWINGS

FIG. 1 is a diagram illustrating an overview of a deposit detection method;

FIG. 2 is a block diagram illustrating a configuration of a deposit detection device;

FIG. 3 is a diagram illustrating pixel rows from which a brightness distribution is to be extracted;

FIG. 4 is a diagram illustrating a process in a calculation module;

FIG. 5 is a diagram illustrating the process in the calculation module;

FIG. 6 is a diagram illustrating an example of a histogram corresponding to a large deposit; and

FIG. 7 is a flowchart illustrating a deposit detection process according to an embodiment.

### DESCRIPTION OF EMBODIMENTS

A deposit detection device and a deposit detection method according to an embodiment will be described in detail below with reference to the accompanying drawings. It should be noted that the present invention is not limited by the embodiment.

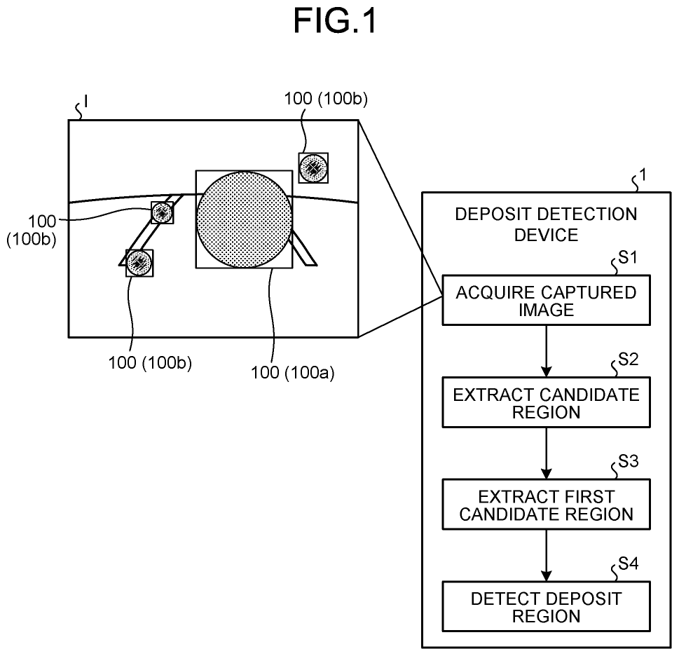

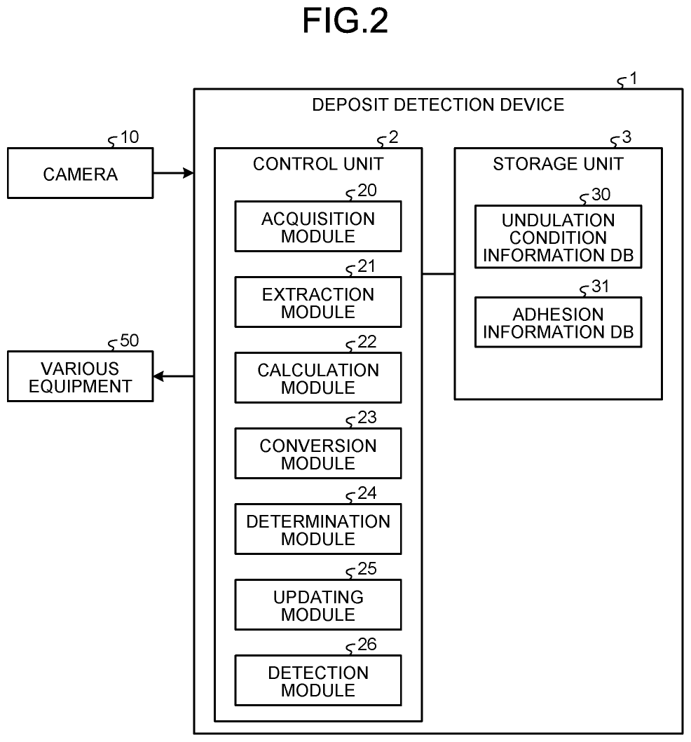

First, referring to FIG. 1, an overview of the deposit detection method according to the embodiment will be described. FIG. 1 is a diagram illustrating the overview of the deposit detection method. The deposit detection method according to the embodiment is performed by a deposit detection device 1. FIG. 1 illustrates a captured image I captured, for example, in a state in which a deposit such as a water droplet adheres to a lens of a camera 10 (refer to FIG. 2) that is an imaging device. Deposits may include dirt, dust, and a snowflake and may be any deposit that blurs the region of the deposit.

The deposit detection device 1 extracts from the captured image I a candidate region 100 in which a deposit may adhere and, when an undulation change pattern of a brightness distribution in the candidate region 100 satisfies a predetermined change pattern, detects the candidate region 100 as a deposit region. The predetermined change pattern is a change pattern of brightness corresponding to a deposit and is preset and stored in an undulation condition information DB 30 (refer to FIG. 2). The undulation change pattern of a brightness distribution will be described later.

A deposit adhering to the lens is assumed to be relatively small and such a deposit has a large amount of change in brightness as depicted in gradation of gray scale in FIG. 1. Thus, the predetermined change pattern is set and stored, based on the amount of change in brightness obtained by experiments and the like.

The deposit detection device 1 then detects a deposit region by comparing the undulation change pattern of the brightness distribution in the candidate region 100 extracted from the captured image I with the predetermined change pattern.

However, when a deposit adhering to the lens is large, the amount of change in brightness is small compared with when a deposit is small. Thus, when a deposit region is detected using the predetermined change pattern described above, the candidate region 100 with a large deposit may fail to be detected as a deposit region.

The deposit detection device 1 according to the embodiment therefore detects as a deposit detection region a candidate region 100 in which a large deposit adheres, by the deposit detection method described below.

The deposit detection device 1 acquires a captured image I (S1) and extracts a candidate region 100 from the acquired captured image I (S2). For example, the deposit detection device 1 extracts a region in the shape of a rectangle including a circular profile of a deposit, as a candidate region 100, by a matching process by pattern matching.

The deposit detection device 1 extracts, as a first candidate region 100a, a candidate region 100 in which the area of the candidate region 100 is equal to or larger than a predetermined area (S3).

The predetermined area is an area in a case where a large deposit adheres and is an area in a case where the width of the candidate region 100 is equal to or greater than a predetermined width (for example, 96 pixels) and the height of the candidate region 100 is equal to or greater than a predetermined height (for example, 96 pixels). Hereinafter, a region in which the area of the candidate region 100 is smaller than the predetermined area is referred to as a second candidate region 100b. The first candidate region 100a and the second candidate region 100b are described as a candidate region 100 when they are not distinguished from each other.

The deposit detection device 1 detects a region in which the amount of brightness change between pixels is equal to or smaller than a predetermined amount of change, as a deposit region, from among the first candidate regions 100a (S4).

The amount of brightness change between pixels is the amount of change in brightness along a predetermined direction in the candidate region 100 and is the difference between the maximum value and the minimum value of brightness in undulation of a brightness distribution of pixels. The predetermined amount of change is a preset value (for example, 32) and is a value by which it can be determined that undulation of brightness is small and a large deposit adheres.

When a large deposit adheres, the deposit detection device 1 can correctly detect the first candidate region 100a as a deposit region and can improve the accuracy in deposit detection.

A configuration of the deposit detection device 1 according to an embodiment will now be described with reference to FIG. 2. FIG. 2 is a block diagram illustrating the configuration of the deposit detection device 1. As illustrated in FIG. 2, the deposit detection device 1 according to an embodiment is connected with the camera 10 and various equipment 50. Although the deposit detection device 1 illustrated in FIG. 2 is a separate component from the camera 10 and the various equipment 50, the deposit detection device 1 may be integrated with at least one of the camera 10 and the various equipment 50.

The camera 10 is, for example, an on-vehicle camera including a lens such as a fish-eye lens and an imager such as a charge-coupled device (CCD) or a complementary metal oxide semiconductor (CMOS). The cameras 10 are provided, for example, at positions where images at the front, back, and sides of the vehicle can be captured, and output the captured images I to the deposit detection device 1.

The various equipment 50 acquires the detection result from the deposit detection device 1 to perform a variety of control on the vehicle. The various equipment 50 includes, for example, a display device indicating that a deposit adheres to the lens of the camera 10 and notifies the user of an instruction to wipe off the deposit, a removal device that ejects fluid, gas, or the like toward the lens to remove the deposit, and a vehicle control device for controlling autonomous driving, for example.

The deposit detection device 1 includes a control unit 2 and a storage unit 3. The control unit 2 includes an acquisition module 20, an extraction module 21, a calculation module 22, a conversion module 23, a determination module 24, an updating module 25, and a detection module 26. The storage unit 3 stores therein the undulation condition information DB 30 and an adhesion information DB 31.

Here, the deposit detection device 1 includes, for example, a computer having a central processing unit (CPU), a read-only memory (ROM), a random-access memory (RAM), a data flash, and an input-output port, and a variety of circuits.

The CPU of the computer reads and executes a computer program stored in the ROM, for example, to function as the acquisition module 20, the extraction module 21, the calculation module 22, the conversion module 23, the determination module 24, the updating module 25, and the detection module 26 of the control unit 2.

At least one or all of the acquisition module 20, the extraction module 21, the calculation module 22, the conversion module 23, the determination module 24, the updating module 25, and the detection module 26 of the control unit 2 may be configured with hardware such as application-specific integrated circuit (ASIC) and field-programmable gate array (FPGA). The acquisition module 20, the extraction module 21, the calculation module 22, the conversion module 23, the determination module 24, the updating module 25, and the detection module 26 may be integrated or divided into a plurality of units.

The storage unit 3 corresponds to, for example, the RAM and the data flash. The RAM and the data flash can store therein information of a variety of computer programs. The deposit detection device 1 may acquire the computer program and/or a variety of information described above through another computer connected via a wired or wireless network or a portable recording medium.

The undulation condition information DB 30 stores therein a predetermined change pattern as undulation condition information. A plurality of predetermined change patterns are set and stored.

The adhesion information DB 31 stores therein adhesion information of the first candidate region 100a in the past captured image I in which a deposit was detected. The adhesion information is rectangular information in the first candidate region 100a.

The rectangular information is information indicating the position and the size of the first candidate region 100a in the captured image I. The rectangular information is the X coordinate and the Y coordinate on the upper left of the first candidate region 100a and the width and the height of the first candidate region 100a. The X coordinate and the Y coordinate are set such that predetermined coordinates in the captured image I are set as the origin. The predetermined coordinates are set at the same position in the captured images I. The rectangular information is stored to be linked with a continuity counter described in detail later.

The acquisition module 20 acquires an image captured by the camera 10 and generates (acquires) a current frame that is the captured image I at present. Specifically, the acquisition module 20 performs a gray-scale process of converting each pixel in the acquired image into grayscale gradation from white to black according to its brightness. The acquisition module 20 also performs a pixel thinning process on the acquired image and generates an image having a size smaller than the acquired image.

The acquisition module 20 generates a current frame that is an integrated image of the sum and the sum of squares of pixel values in the pixels, based on the image subjected to the thinning process. As used herein, a pixel value is information corresponding to brightness or an edge of a pixel. In this way, the deposit detection device 1 can accelerate calculation in the processes in the subsequent stages by performing the thinning process on the acquired image and generating the integrated image and can reduce the process time for detecting a deposit.

The acquisition module 20 may perform a smoothing process for each pixel, using a smoothing filter such as an averaging filter. The acquisition module 20 does not necessarily perform the thinning process and may generate a current frame having the same size as that of the acquired image.

The extraction module 21 extracts the candidate region 100 from the captured image I acquired by the acquisition module 20. Specifically, first, the extraction module 21 extracts brightness and edge information of each pixel in the captured image I. The brightness of each pixel is represented by, for example, a parameter from 0 to 255.

The extraction module 21 performs an edge detection process based on the brightness of each pixel to detect an edge in an X-axis direction (the right-left direction in the captured image I) and an edge in a Y-axis direction (the top-bottom direction in the captured image I) for each pixel. In the edge detection process, for example, any edge detection filter such as a Sobel filter and a Prewitt filter can be used.

The extraction module 21 then detects a vector including information on the edge angle and the edge intensity of the pixel as edge information, using a trigonometric function, based on the edge in the X-axis direction and the edge in the Y-axis direction. Specifically, the edge angle is represented by the direction of the vector and the edge intensity is represented by the length of the vector.

The extraction module 21 then performs a matching process (template matching) between template information indicating the profile of a deposit created in advance and the detected edge information and extracts edge information similar to the template information.

The extraction module 21 performs the matching process a number of times, specifically, twice. The extraction module 21 performs a first matching process between the template information and all pieces of the detected edge information and thereafter performs a second matching process between the template information and edge information thinned out from the detected edge information.

In the second matching process, edge information in the X-axis direction is extracted at a predetermined skip width (pixel interval), and edge information in the Y-axis direction is extracted at a predetermined skip width. The predetermined skip is a preset interval, for example, four pixels. For example, in successive pixels from 1 to 15 in the X-axis direction, each piece of the edge information of the first pixel, the fifth pixel, the ninth pixel, and the thirteenth pixel is extracted.

The number of times of the matching process is not limited to twice and may be three or more times. In this case, the extraction module 21 changes the predetermined skip width and performs the matching process a number of times.

The extraction module 21 then extracts a region of the extracted edge information, that is, a candidate region 100 that is a region in the shape of a rectangle including the profile of a deposit. The extraction module 21 extracts a candidate region 100 at the first matching process and the second matching process.

The extraction module 21 extracts a candidate region 100 based on the amount of feature of pixels obtained by skipping by the predetermined skip width, at the second matching process. The extraction module 21 extracts a candidate region 100 at the second matching process without newly generating a reduced captured image I.

The candidate region 100 extracted at the second matching process is a region including pixels having thinned edge information and is a region having a size on the captured image I.

The extraction module 21 extracts, as the first candidate region 100a, a candidate region 100 in which the area of the candidate region 100 is equal to or larger than the predetermined area and extracts, as the second candidate region 100b, a candidate region 100 in which the area of the candidate region 100 is smaller than the predetermined area.

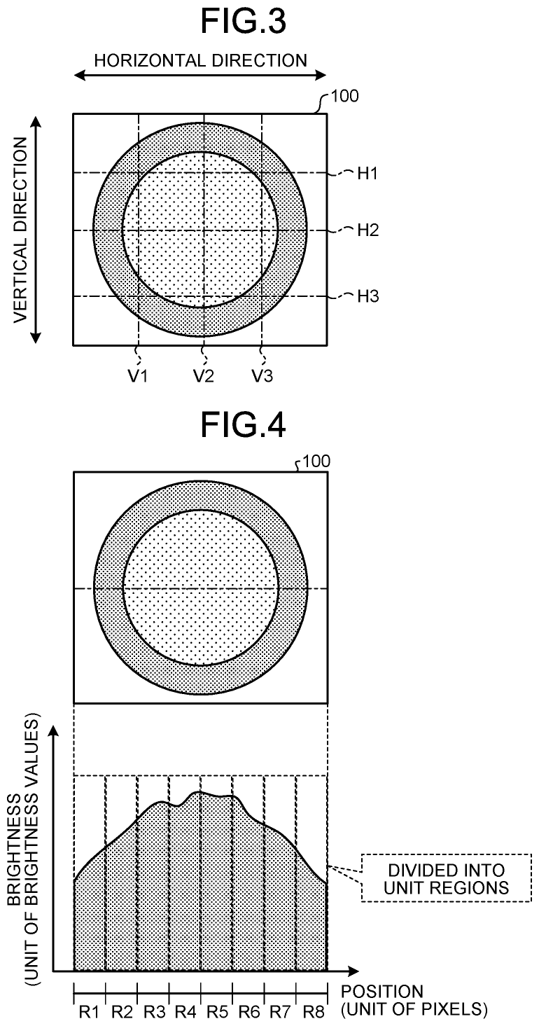

The extraction module 21 extracts a brightness distribution of predetermined pixel rows in the candidate region 100. FIG. 3 is a diagram illustrating pixel rows from which a brightness distribution is to be extracted. As illustrated in FIG. 3, the extraction module 21 extracts a brightness distribution for three pixel rows H1 to H3 in the horizontal direction (X-axis direction) and three pixel rows V1 to V3 in the vertical direction (Y-axis direction) in the captured image I. With this process, the brightness distribution can be handled as two-dimensional information, and process loads at the subsequent stages can be reduced.

The extraction module 21 also extracts a brightness distribution of predetermined pixel rows, for a region corresponding to the rectangular information stored in the adhesion information DB 31, in the same manner as in the candidate region 100. That is, in the captured image I, the extraction module 21 extracts from the captured image I a region that matches the rectangular information stored in the adhesion information DB 31 and extracts a brightness distribution of pixel rows for the extracted region. Hereinafter, the region corresponding to the rectangular information stored in the adhesion information DB 31 is referred to as “auxiliary region”.

The pixel rows to be extracted may be pixel rows in one of the horizontal direction or the vertical direction. The number of pixel rows to be extracted is not limited to three and may be two or less or four or more. The extraction module 21 extracts brightness distributions of pixel rows in the horizontal direction and the vertical direction in the first candidate region 100a and the auxiliary region.

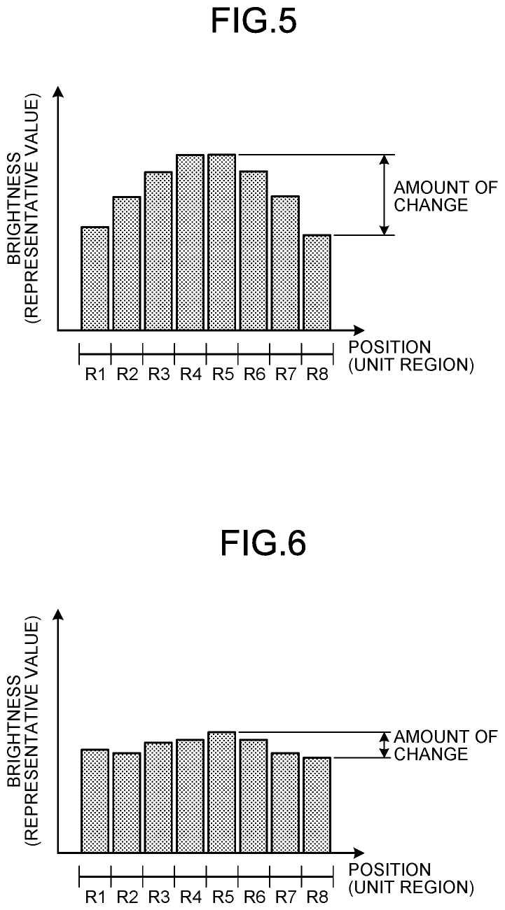

Returning back to FIG. 2, the calculation module 22 is described. The calculation module 22 divides the candidate region 100 into unit regions each having a predetermined number of pixels as a unit, and calculates a representative value of brightness for each unit region. The method of calculating a representative value by the calculation module 22 will be described later with reference to FIG. 4 and FIG. 5.

FIG. 4 and FIG. 5 are diagrams illustrating a process in the calculation module 22. First, referring to FIG. 4, a method of setting unit regions by the calculation module 22 is described. FIG. 4 illustrates a brightness distribution of one pixel row H in the horizontal direction.

As illustrated in FIG. 4, the calculation module 22 divides a pixel row in the horizontal direction into, for example, eight unit regions R1 to R8 (which may be collectively referred to as unit regions R). The widths (number of pixels) of the unit regions R1 to R8 may be the same (that is, the number of pixels obtained by equally dividing the pixel row), or the widths may be different from each other.

The number of divided unit regions R is not limited to eight and any number may be set. It is preferable that the number of divided unit regions R be the same (in FIG. 4, eight) in all the candidate regions 100 extracted from the captured image I and the auxiliary region, irrespective of the sizes thereof. With this process, even when the extracted candidate regions 100 and the auxiliary region have various sizes, unified information can be obtained by setting the same number of unit regions R, thereby suppressing process loads in the determination process and the like at the subsequent stages.

As illustrated in FIG. 5, the calculation module 22 constructs a histogram of a representative value of brightness for each of the unit regions R1 to R8. Specifically, the calculation module 22 calculates the average value of brightness values for each of the unit regions R1 to R8 and sets the average value as a representative value of brightness.

The constructed histogram varies in shape depending on the state of a deposit. As illustrated in FIG. 5, in the histogram of a small deposit, for example, the brightness of the unit regions R4 and R5 in the vicinity of the center is large, and the brightness of the unit regions R1 and R8 in the vicinity of the ends is small. Thus, the amount of change in brightness in the unit regions R is large. The change pattern of brightness in the histogram is the undulation change pattern of a brightness distribution.

On the other hand, as illustrated in FIG. 6, in the histogram of the large deposit, the amount of change in brightness in the unit regions R is small. FIG. 6 is a diagram illustrating an example of the histogram corresponding to the large deposit.

The calculation module 22 calculates the amount of brightness change between pixels in the first candidate region 100a, using the constructed histogram. The calculation module 22 also constructs a histogram similarly for the auxiliary region and calculates the amount of brightness change between pixels. The calculation module 22 constructs a histogram for each pixel row and calculates the amount of brightness change between pixels.

Returning back to FIG. 2, the determination module 24 determines whether the calculated amount of brightness change between pixels is equal to or smaller than the predetermined amount of change, for the first candidate region 100a. The determination module 24 determines whether the calculated amount of brightness change between pixels is equal to or smaller than the predetermined amount of change, for the extracted pixel rows.

The determination module 24 determines that the first candidate region 100a in which the amount of brightness change between pixels is equal to or smaller than the predetermined amount of change is a deposit region. Specifically, the determination module 24 determines that the first candidate region 100a in which the amount of brightness change between pixels is equal to or smaller than the predetermined amount of change is a deposit region in all of the extracted pixel rows.

The determination module 24 determines that the first candidate region 100a in which the amount of brightness change between pixels is larger than the predetermined amount of change is not a deposit region. Specifically, the determination module 24 determines that the first candidate region 100a is not a deposit region when the amount of brightness change between pixels is larger than the predetermined amount of change in any one of the extracted pixel rows.

The determination module 24 determines whether the amount of brightness change between pixels is equal to or smaller than the predetermined amount of change, for the auxiliary region, in the same manner as in the first candidate region 100a. The determination module 24 determines that the auxiliary region in which the amount of brightness change between pixels is equal to or smaller than the predetermined amount of change is a deposit region.

The first candidate region 100a is sometimes extracted from the candidate region 100 extracted from the captured images I at the aforementioned second matching process. In the second matching process, the process of matching with the template information is performed using the edge information of the pixels obtained by skipping by the predetermined skip width. Thus, the first candidate region 100a is sometimes not extracted from the captured image I.

The deposit detection device 1 according to the embodiment determines whether the amount of brightness change between pixels is equal to or smaller than the predetermined amount of change, even for the auxiliary region, and determines, as a deposit region, the auxiliary region in which the amount of brightness change between pixels is equal to or smaller than the predetermined amount of change. With this process, the deposit detection device 1 can accurately detect as a deposit region a region in which a large deposit adheres.

The determination module 24 also determines whether the undulation change pattern of the brightness distribution satisfies the predetermined change pattern, for the second candidate region 100b. The predetermined change pattern includes a threshold value range for each unit region R. The determination module 24 determines whether the representative value of each unit region R in the second candidate region 100b is included in the threshold value range of the unit region R in the predetermined change pattern.

The determination module 24 determines that the second candidate region 100b in which the undulation change pattern of the brightness distribution satisfies the predetermined change pattern is a deposit region. The determination module 24 determines that the second candidate region 100b in which the undulation change pattern of the brightness distribution does not satisfy the predetermined change pattern is not a deposit region.

In addition, when the candidate region 100 is successively determined as a deposit region, based on the time-series captured images I, the determination module 24 determines that the candidate region 100 is an identified region of a deposit region.

The determination module 24 also performs a final determination for a deposit by calculating the occupancy ratio of the identified region. Specifically, the determination module 24 determines that a deposit adheres to the lens of the camera 10 when the occupancy ratio is equal to or larger than a preset threshold value (for example, 40%). The determination module 24 determines that a deposit does not adhere to the lens of the camera 10 when the occupancy ratio is smaller than the threshold value.

The updating module 25 sets a deposit detection flag to “ON” when it is determined that a deposit adheres to the lens of the camera 10. The updating module 25 sets the deposit detection flag to “OFF” when it is determined that a deposit does not adhere to the lens of the camera 10.

The updating module 25 updates the adhesion information DB 31. The updating module 25 newly stores rectangular information of the first candidate region 100a determined as a deposit region in the adhesion information DB 31 when the rectangular information of the first candidate region 100a is not stored therein.

When the auxiliary region corresponding to the rectangular information stored in the adhesion information DB 31 is not determined as a deposit region successively a predetermined number of times (for example, three times), the updating module 25 deletes the rectangular information of the region not determined as a deposit region from the adhesion information DB 31. Specifically, when the auxiliary region is not determined as a deposit region, the updating module 25 increments the continuity counter of the rectangular information corresponding to the auxiliary region. The continuity counter is a value indicating the continuity of deposit non-detection in a region that matches the rectangular information stored in the adhesion information DB 31.

The continuity counter is set to zero as an initial value. When the auxiliary region is determined as a deposit region, the updating module 25 resets the continuity counter of the rectangular information corresponding to the auxiliary region determined as a deposit region. When the continuity counter reaches a predetermined value (for example, “3”), the updating module 25 deletes the rectangular information having the continuity counter reaching the predetermined value from the adhesion information DB 31.

The detection module 26 detects a deposit region from the candidate region 100, based on the determination result by the determination module 24. The detection module 26 detects an identified region of a deposit region, based on the determination result by the determination module 24.

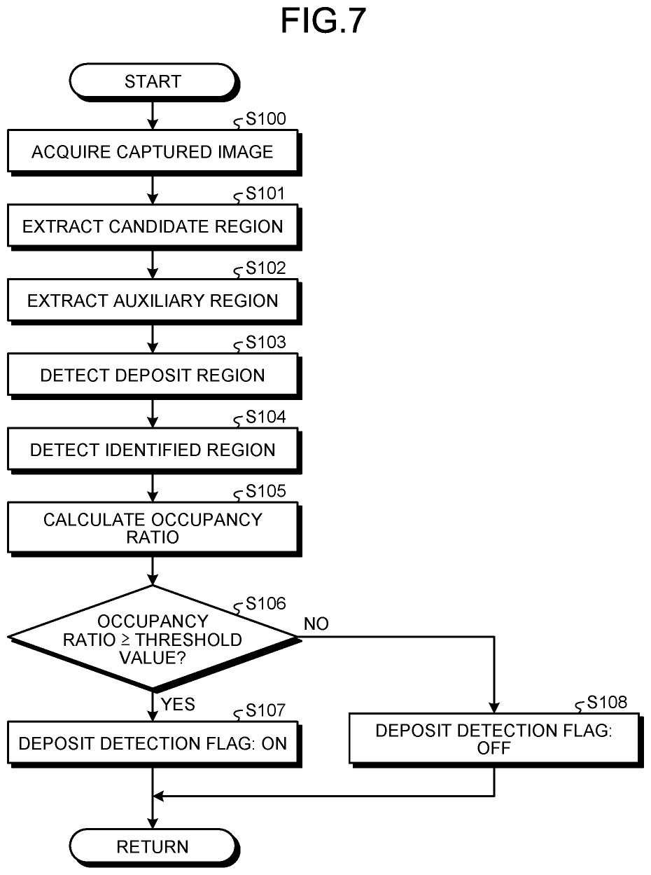

A deposit detection process according to the embodiment will now be described with reference to FIG. 7. FIG. 7 is a flowchart illustrating the deposit detection process according to the embodiment.

The control unit 2 acquires an image captured by the camera 10 and performs a gray-scale process and a thinning process on the acquired image, and thereafter acquires an integrated image generated based on pixel values of the reduced image as a captured image I (S100).

The control unit 2 extracts a candidate region 100 for a deposit region corresponding to a deposit adhering to the camera 10, based on edge information detected from the pixels of the captured image I (S101). Specifically, the control unit 2 extracts a first candidate region 100a and a second candidate region 100b. The control unit 2 then extracts an auxiliary region (S102).

The control unit 2 detects a deposit region (S103). Specifically, the control unit 2 detects, as deposit regions, a first candidate region 100a and an auxiliary region in which the amount of brightness change between pixels is equal to or smaller than the predetermined amount of change. The control unit 2 also detects, as a deposit region, a second candidate region 100b in which the undulation change pattern of a brightness distribution satisfies the predetermined change pattern.

The control unit 2 detects an identified region of the deposit region (S104). The control unit 2 calculates the occupancy ratio (S105) and determines whether the occupancy ratio is equal to or larger than a threshold value (S106). If the occupancy ratio is equal to or larger than a threshold value (Yes at S106), the control unit 2 sets the deposit detection flag to “ON” (S107). If the occupancy ratio is smaller than a threshold value (No at S106), the control unit 2 sets the deposit detection flag to “OFF” (S108).

The deposit detection device 1 extracts a region in which the area is equal to or larger than the predetermined area, as the first candidate region 100a, from among the candidate regions 100 and detects the first candidate region 100a in which the amount of brightness change between pixels is equal to or smaller than the predetermined amount of change, as a deposit region.

With this process, the deposit detection device 1 can detect as a deposit region a region in which a large deposit adheres and can improve the accuracy in deposit detection.

The deposit detection device 1 detects, as a deposit region, the first candidate region 100a in which the amounts of brightness change between pixels in pixel rows in the horizontal direction and the vertical direction in the first candidate region 100a are equal to or smaller than the predetermined amount of change.

With this process, the deposit detection device 1 can detect as a deposit region the first candidate region 100a in which a deposit adheres and can improve the accuracy in deposit detection.

The deposit detection device 1 extracts the first candidate region 100a based on the amount of feature of pixels obtained by skipping by the predetermined skip width.

With this process, the deposit detection device 1 can extract the first candidate region 100a without generating a new reduced image for extracting the first candidate region 100a. The deposit detection device 1 can extract the first candidate region 100a using the template information for extracting the second candidate region 100b. The deposit detection device 1 therefore can reduce the process load in deposit detection.

The deposit detection device 1 detects a region in which the amount of brightness change is equal to or smaller than the predetermined amount of change, as a deposit region, from among the auxiliary regions corresponding to the rectangular information stored in the adhesion information DB 31.

With this process, even when the first candidate region 100a fails to be extracted at the second matching process, the deposit detection device 1 can perform deposit adhesion determination for the auxiliary region in which a large deposit may adhere. The deposit detection device 1 therefore can improve the accuracy in deposit detection.

The deposit detection device 1 deletes the rectangular information having the continuity counter reaching a predetermine value from the adhesion information DB 31.

With this process, the deposit detection device 1 can suppress the deposit adhesion determination based on the rectangular information corresponding to a region in which a deposit does not adhere and can suppress the process load in deposit detection. The deposit detection device 1 also can improve the accuracy in deposit detection.

The deposit detection device 1 according to a modification may determine whether the second candidate region 100b is an adhesion region by performing the following process.

The deposit detection device 1 according to the modification converts the brightness values (for example, 0 to 255) of pixels in the second candidate region 100b into unit brightness (for example, 0 to 7). Specifically, the deposit detection device 1 according to the modification equally divides 0 to 255 into eight unit brightness. The deposit detection device 1 according to the modification then calculates a representative value (for example, the unit brightness of the mode or the average value of unit brightness) for each unit region R and calculates the amount of change in unit brightness between adjacent unit regions R.

The deposit detection device 1 according to the modification then calculates a pattern of the amount of change in unit brightness as a pattern of undulation change of the brightness distribution and, when the pattern of undulation change of the brightness distribution satisfies a predetermined change pattern, detects the second candidate region 100b as a deposit region.

With this process, the deposit detection device 1 according to the modification can ignore the overall magnitude of brightness values and therefore can reduce erroneous determination caused when the shape of undulation is similar and the magnitude of brightness values is different. Since the magnitude of brightness values can be ignored, there is no need for setting a determination condition for each brightness value, whereby the deposit detection device 1 according to the modification can reduce the storage capacity for storing the conditions. In addition, since there is no need for performing the determination process for each brightness value, the deposit detection device 1 according to the modification can reduce processing volume.

The deposit detection device 1 according to the modification may also perform deposit determination using the unit brightness in the first candidate region 100a and the auxiliary region.

As described above, according to an aspect of the embodiment, the accuracy in deposit detection can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A deposit detection device comprising:
an extraction module configured to extract a candidate region for a deposit from a captured image captured by an imaging device; and
a detection module configured to detect, as a deposit region, a region in which an area of the candidate region is equal to or larger than a predetermined area and an amount of brightness change between pixels in the candidate region is equal to or smaller than a predetermined amount of change.

2. The deposit detection device according to claim 1, wherein the detection module detects, as the deposit region, a region in which the area of the candidate region is equal to or larger than the predetermined area and each of the amounts of brightness change between pixels in pixel rows in a horizontal direction and a vertical direction in the candidate region is equal to or smaller than the predetermined amount of change.

3. The deposit detection device according to claim 1, wherein the extraction module extracts the candidate region based on an amount of feature of pixels obtained by skipping by a predetermined skip width in the captured image.

4. The deposit detection device according to claim 1, further comprising a storage unit configured to store rectangular information of the deposit region detected in a past captured image, wherein
the detection module detects, as the deposit region, a region in which the amount of brightness change is equal to or smaller than the predetermined amount of change from among regions corresponding to the rectangular information stored in the storage unit.

5. The deposit detection device according to claim 4, further comprising an updating module configured to delete, from the storage unit, the rectangular information in which a value indicating continuity of deposit non-detection in a region corresponding to the rectangular information stored in the storage unit reaches a predetermined value.

6. A deposit detection method comprising:
extracting a candidate region for a deposit from a captured image captured by an imaging device; and
detecting, as a deposit region, a region in which an area of the candidate region is equal to or larger than a predetermined area and an amount of brightness change between pixels in the candidate region is equal to or smaller than a predetermined amount of change.
